(19) United States
(12) Patent Application Publication
(10) Pub. No.: US 2006/0174974 A1
(43) Pub. Date: Aug. 10, 2006

(54) Floorboard and floor convering for resilient floor

(76) Inventors: Hans Brannstrom, Nybro (SE); Wolfgang Trost, Nybro (SE); Leif Israelsson, Nybro (SE)

Correspondence Address: HARNESS, DICKEY & PIERCE, P.L.C., P.O. BOX 8910, RESTON, VA, 20195, US

(21) Appl. No.: 10/534,861

(22) PCT Filed: Nov. 3, 2003
(86) PCT No.: PCT/SE03/01690

§ 371 Date: Jan. 4, 2006

(30) Foreign Application Priority Data
Nov. 12, 2002 (SE) 0203339-7

(51) Int. Cl. B27M 3/00

(52) U.S. Cl. 144/345

(57) ABSTRACT

A floorboard for making a resilient floor by joining to at least one neighbouring, substantially identical floorboard (1′), so that joined upper neighbouring parts (7, 7′) of the edge portions of the floorboards (1, 1′) together define a joint plane (F), perpendicular to the main plane (P) of the joined floorboards, comprises a resilient base (10) which is arranged on the underside of the floorboard (1, 1′) and which extends beyond said joint plane (F), supporting layer (1 1) which is arranged between the underside of the floorboard (1) and the resilient base (10), and a locking system, which is arranged along at least two parallel edges (25a, 25b; 26a, 26b) of the floorboard (1) and integrated with the floorboard, for mechanical joining, vertically (D1) and horizontally (D2), of the floorboard (1) to the neighbouring, substantially identical floorboard (1′). Furthermore, a kit of parts and a method for installation of resilient floors as well as a method for manufacturing resilient floors are disclosed.

### FIELD OF THE INVENTION

The present invention relates to floorboards for making a resilient or energy-absorbing floor, i.e. a flooring for sports or other activities.

### BACKGROUND ART

The term “sports floor” relates to resilient floorings that exhibit sufficient resilience, bouncing effect or impact-absorbing capability to be suited for sports activities, dancing or other activities where a flooring that is kind to the users is desired.

There are mainly three categories of sports floor: i) point-elastic floors which consist of an elastic soft layer (i.e. a carpet) which is glued immediately to a hard base; ii) surface-elastic floors which consist of a comparatively flexurally rigid upper layer of assembled floorboards resting on a resilient carpet or on joists or spacer blocks which in turn rest on the base; and iii) combined constructions involving a carpet and joists or spacer blocks.

Category ii) includes, inter alia, U.S. Pat. No. 4,819,932 which discloses a sports floor where solid floorboards, which are joined mechanically, are laid on a subfloor consisting of a large resilient base which gives the floor resilient properties. Category ii) also includes DE 860 40 04 U1, which discloses a sports floor where floorboards, which are joined mechanically, are laid on a subfloor consisting of a resilient base made up of a plurality of adjoining boards. The boards constituting the resilient base are laid so that their joints do not coincide with the joints of the floorboards.

One type of sports floor of category iii) is shown, for instance, in U.S. Pat. No. 5,778,621, where an upper layer of floorboards rests on a carpet, which in turn rests on resilient joists arranged on the base.

Furthermore U.S. Pat. No. 6,044,606 discloses a sports floor where resilient pads are arranged on the upper side of the subfloor.

EP 0 455 616 discloses a sports floor where a resilient material is arranged in grooves in the underside of the floorboards. Moreover, the floorboards shown in EP 0 455 616 are intended to be glued together to form a floor.

A frequent type of floorboards consists of a core and also a surface layer and a balancing layer. The core often consists of wood or wood fibre-containing material, such as MDF (Medium Density Fibreboard), HDF (High Density Fibreboard), particle board or plywood. The surface layer may be, for example, a thin hard decorative layer as found on so-called laminate floors. Alternatively, the surface layer may consist of wood or veneer, which can be treated to withstand wear, moisture etc: and which can be so thick as to allow regrinding of the floor. The function of the balancing layer is to prevent the floor from bending when exposed to, for instance, moisture or variations in temperature.

As shown in WO 94/26999, the floorboard can also be provided with a lower layer, such as a sound-absorbing layer for impact sound insulation. However, this layer should not be elastic since it should be capable of taking up irregularities of the base.

With a view to joining two or more floorboards to form a flooring, a plurality of different systems for mechanical joining of floorboards are known. Examples of such systems are shown in U.S. Pat. No. 4,426,820, DE-121 11 75, DE-198 51 200 C1, FR-267 51 74, WO 99/66151, WO 97/47834, JP 3169967, WO 96/27721, GB 143 04 23 and in WO 02/55809. Also U.S. Pat. No. 4,819,932 discloses a system for mechanical joining of floorboards along their long sides.

The above-mentioned sports floors, however, suffer from several drawbacks. One is that they are complex and consist of a large number of different parts that are to be assembled. This can take a relatively long time, which results in a high cost of installation. Another drawback is that they often take up a large space in the vertical direction. A plurality of the known sports floors are also difficult to disassemble, for instance when they are to be moved or in connection with repair and exchange of individual floorboards.

### SUMMARY OF THE INVENTION

An object of the present invention is to provide a floorboard which with maintained strength wholly or partly eliminates the above problems.

The object is achieved by means of a floorboard, a resilient floor, a kit of parts and methods according to the independent claims. Embodiments of the invention will appear from the dependent claims and also from the following description.

According to a first aspect of the invention, a floorboard is thus provided for making a resilient floor by joining to at least one neighbouring, substantially identical floorboard, so that joined upper neighbouring parts of the edge portions of the floorboards together define a joint plane, perpendicular to the main plane of the joined floorboards. The floorboard is characterised by a resilient base which is arranged on the underside of the floorboard and which extends beyond said joint plane, a supporting layer which is arranged between the underside of the floorboard and the resilient base, and a locking system, which is arranged along at least two parallel edges of the floorboard and integrated with the floorboard, for mechanical joining, vertically and horizontally, of the floorboard to the neighbouring, substantially identical floorboard.

By “resilient base” is meant an elastic material that is capable of absorbing and emitting energy, i.e. that has a resilient function. According to one embodiment, the resilient base can have a greater thickness than the floorboard. The composition of materials, the thickness as well as the extent of the resilient base under the floorboard can be varied for the purpose of adjusting the floorboard to different applications, such as different types of sport.

By the resilient base being “arranged” is meant that the resilient base is fixedly arranged on the floorboard. According to one embodiment, the resilient base is already arranged on the floorboard at the factory where the floorboard is manufactured.

With a floorboard of this type, a resilient floor can be provided practically as easily and quickly as a traditional parquet floor since the floorboards are complete when leaving the factory. Moreover, a small overall height is obtained since no complicated systems of joists are required.

By “edge portions” are meant portions along the edges of the floorboard. The “upper neighbouring parts” can, but need not, be in contact with each other when two floorboards are in a joined state. Furthermore they can have a very small vertical extent and be positioned anywhere in the upper part of the joint edge portion of the floorboard. According to one embodiment, the “neighbouring parts” can be the verge of the surface layer of the respective floorboards.

By the resilient base being arranged on the underside of the floorboard, the floorboard can quickly and easily be laid and taken up, which reduces the cost of installation.

By the resilient base extending beyond the joint plane, the resilient base will be offset relative to the joint between the floorboards, which increases the strength of the sports floor.

According to one embodiment, the resilient base is arranged so that, with the floorboards in a joined state, it extends at least partly under the neighbouring, substantially identical floorboard. By one and the same resilient base supporting the floorboard on which it is arranged and also the neighbouring floorboard, the two floorboards will move to the same extent in the vertical direction when subjected to load, thereby increasing the strength in the joint.

According to another embodiment, the floorboard comprises a supporting layer, which is arranged between the underside of the floorboard and the resilient base. The supporting layer reduces the load applied to the mechanical locking system, especially when a mechanical locking system has been selected.

The supporting layer can have a greater modulus of elasticity than the resilient base. Materials that can be used for the supporting layer comprise, but are not limited to, MDF, HDF, plywood, particle board, wood material, plastic material or metal, such as aluminium. By the supporting layer being made more rigid than the resilient base, the load applied to the mechanical locking system will be reduced.

The horizontal extent of the supporting layer can be smaller than a horizontal extent of the floorboard. By “horizontal extent” is meant the extent in a direction which is perpendicular to the edge portion and parallel to the surface of the floorboard. The horizontal extent of the supporting layer can be less than half the horizontal extent of the floorboard perpendicular to the joint plane.

The floorboard can along at least two parallel edges comprise a locking system integrated with the floorboard and intended for mechanical joining, vertically and horizontally, of the floorboard to the neighbouring, substantially identical floorboard.

By the locking system being “integrated” is meant that it is factory-mounted on the floorboard, or alternatively formed in one piece with the body of the floorboard.

With a mechanical locking system, a high surface finish is achieved by the locking system ensuring the fit of the joints. Moreover it will be a quick operation to install floorboards with a mechanical locking system. They can also be taken up to be used in a different location, or to replace individual floorboards that have been damaged.

The resilient base can extend beyond an outer part of the locking system of the floorboard. By the resilient base extending beyond an outer part of the locking system of the floorboard, the strength is further increased.

According to a second aspect, the invention provides a flooring for resilient floors, which comprises floorboards of the type as described above.

According to a third aspect, the invention provides a kit of parts for making a resilient floor. The kit is characterised by a floorboard for joining to a neighbouring, substantially identical floorboard, so that joined upper neighbouring parts of the edge portions of the floorboards together define a joint plane, which is perpendicular to the main plane of the joined floorboards, and a resilient base, which in terms of shape and size is adapted to be arranged on the underside of the floorboard, so that the resilient base extends beyond said joint plane, and a supporting layer, which in terms of size and shape is adapted to be arranged between said floorboard and said resilient base, the floorboard along at least two parallel edges being provided with a locking system integrated with the floorboard, for mechanical joining, vertically and horizontally, of the floorboard to the neighbouring, substantially identical floorboard.

The resilient base can be cut and, thus, adapted in advance to the floorboard in terms of size and shape. Alternatively, the resilient base can be delivered non-cut, for instance on a roll. According to this aspect, the resilient base can be mounted on the floorboard before or in connection with installation of the floorboard.

According to a fourth aspect, the invention provides a method for making a resilient floor by joining a floorboard to a neighbouring, substantially identical floorboard, so that joined upper neighbouring parts of the edge portions of the floorboards together define a joint plane, which is perpendicular to the main plane of the joined floorboards. The method is characterised by joining the floorboards so that a resilient base and a supporting layer, which are arranged on the underside of the floorboard, extend beyond said joint plane, said joining comprising mechanical joining, vertically and horizontally, of the floorboard to the neighbouring, substantially identical floorboard.

The method is a quick and simple way of installing a resilient floor on an existing base.

According to a fifth aspect, the invention provides a method for manufacturing a floorboard for making a resilient floor. The method is characterised by providing a floorboard, which is designed for joining to a neighbouring, substantially identical floorboard, so that joined upper neighbouring parts of the edge portions of the floorboards together define a joint plane, which is perpendicular to the main plane of the joined floorboards, arranging on the underside of the floorboard a resilient base, which extends beyond said joint plane, arranging a supporting layer between said floorboard and said resilient base, and arranging along at least two parallel edges of the floorboard a locking system integrated with the floorboard, for mechanical joining, vertically and horizontally, of the floorboard to the neighbouring, substantially identical floorboard.

### BRIEF DESCRIPTION OF THE DRAWINGS

The invention will now be described in more detail with reference to the accompanying schematic drawings, which show examples of embodiments of the invention.

FIGS. 1a and 1b are schematic cross-sectional views of two edges, provided with a mechanical locking system, of two neighbouring floorboards 1, 1′, which are provided with a resilient base 10 according to a first embodiment of the invention.

FIGS. 2a and 2b are schematic cross-sectional views of two edges; provided with a-mechanical locking system, of two neighbouring floorboards 1, 1′, which are provided with a resilient base 10 and/or a supporting layer according to a second embodiment of the invention.

FIGS. 3a-3c illustrate a floorboard with a mechanical locking system, a resilient base and a supporting layer according to a third embodiment of the invention.

FIGS. 4a-4c show different ways of arranging the resilient base 10, 10a, 10b, 10c and/or the supporting layer 11, 11a, 11b, 11c on the underside of a floorboard 1, 1′.

FIG. 5 shows further ways of arranging the resilient base 10, 10a, 10b, 10c and/or the supporting layer 11, 11a, 11b, 11c on the underside of a floorboard 1, 1′.

FIG. 6 shows another way of arranging the resilient base 10b, 10c and/or the supporting layer 11b, 11c on the underside of a floorboard.

### DESCRIPTION OF EMBODIMENTS

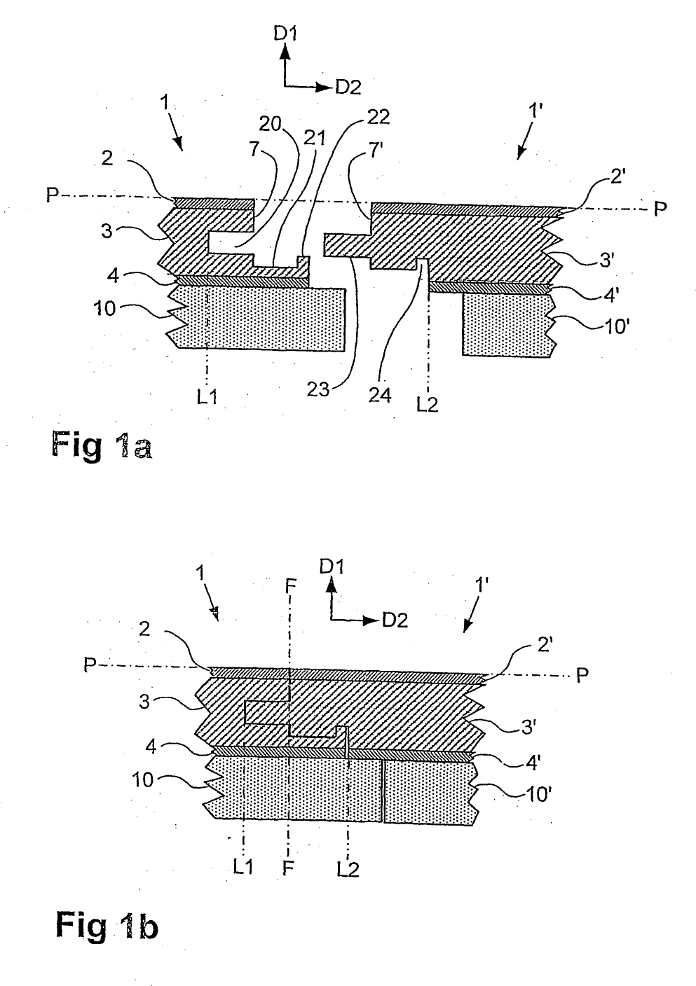

FIGS. 1a-1b schematically illustrate a first embodiment of a floorboard according to the invention. In FIGS. 1a-1b, the floorboard is shown to be provided with a mechanical locking system, which has-a tongue 23 and a groove 20 for locking in the vertical direction. Moreover, the locking system comprises a projecting strip 21 extending under the neighbouring floorboard 1′ and supporting a locking element 22, which cooperates with a downwardly open locking groove 24 in the neighbouring floorboard 1′. The mechanical locking system shown in FIGS. 1a and 1b can be of the type as disclosed in WO 94/26999 or WO 99/66151. However, it will be appreciated that other locking system may also be used. The edge portions shown in FIGS. 1a-1b can be long sides 25a, 25b or short sides 26a, 26b of a floorboard 1.

A resilient base 10 is arranged on the underside of the floorboard 1 shown in FIGS. 1a and 1b. The resilient base 10 gives the sports floor resilience and an impact-absorbing capability. The resilient base 10 is arranged on the floorboard, i.e. it is mounted on the floorboard in connection with manufacture at the factory.

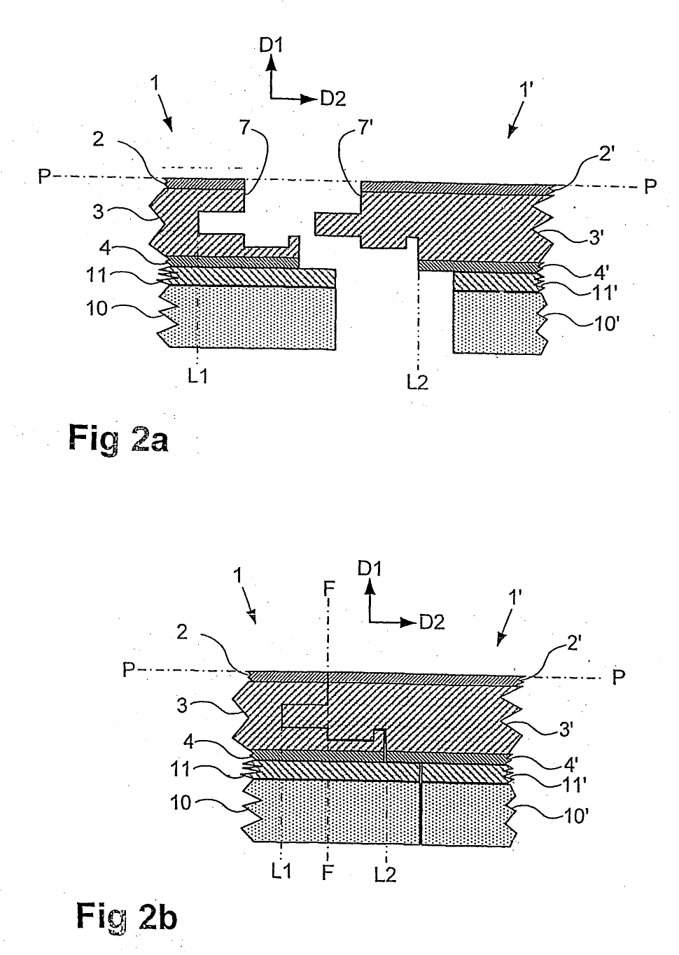

Moreover, an inner part L1 of the locking system, seen from the joint plane F, and outer part L2 of the locking system, seen from the joint plane F, are defined in FIGS. 1a-1b. The inner part L1 of the locking system is the part where the locking system ends, seen from the joint plane F and inwards to the floorboard, i.e. the part where the floorboard becomes homogeneous. The outer part L2 of the locking system is the part where the locking system ends, seen from the joint plane and outwards from the floorboard. It will be appreciated that even if L1 and L2 in FIG. 2 are defined based on the left floorboard 1, they can also be defined based on the right floorboard 1′.

According to one embodiment of the invention, the resilient base 10 may extend outside the joint plane F, as is the case with the left floorboard 1 in FIG. 1a. Correspondingly, the resilient base 10′ of the right floorboard 1′ in FIG. 1a can be retracted relative to the joint plane F for the purpose of allowing joining of the floorboards 1, 1′.

According to another embodiment, the resilient base 10 of the left floorboard 1 can extend also beyond the outer-part L2 of the locking system, which is shown in FIG. 1a. The resilient base 10′ of the right floorboard 1′ can in this case be retracted to a corresponding, or greater, extent. It will be appreciated that the projecting part of the resilient base can also be arranged on the right floorboard in FIG. 1.

According to one more embodiment, the resilient base 10 can extend so far under the neighbouring floorboard (in the joined state) that the core of the neighbouring floorboard will rest on the resilient base.

The sports floor which is made by means of the described floorboard 1 is arranged in such a manner that a joint between two floorboards rests on a resilient base which extends under the two floorboards.

It will be appreciated that the resilient base 10 can be arranged so as to extend beyond the joint plane F on the long side as well as on the short side of the floorboard. Just as the design of the locking system may differ between the long side and the short side, also the extent of the resilient base 10 may differ between the short side and the long side. For example, the resilient base may extend further beyond the joint plane on the short side than it does on the long side, but the opposite is also possible.

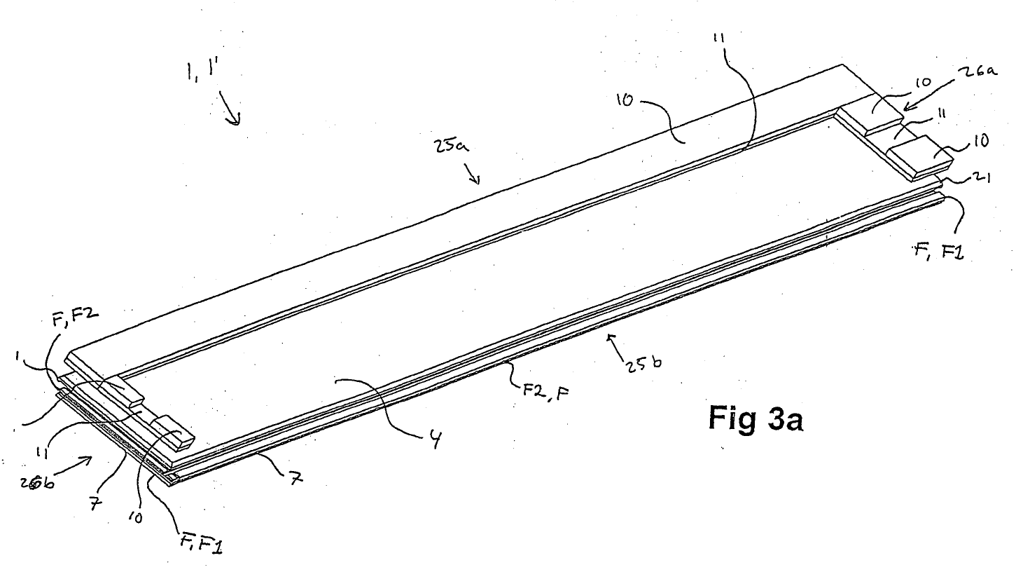

Further the resilient base 10 can be arranged so as to extend continuously along substantially the entire length of the edge of the floorboard 1 as shown in FIG. 3a. By “substantially” is here meant that the resilient base can deviate somewhat from the length of the edge of the floorboard. Moreover, for instance the length of the resilient base along the long side of the floorboard can be designed so that the short sides of the floorboard can be connected to short sides (or, in some cases, also long sides) of other floorboards 1′. Optionally, the resilient base can be arranged discontinuously, as a plurality of separated and spaced-apart resilient bases arranged along the edge. An example of this is shown regarding the short side of the floorboard shown in FIG. 3.

Furthermore the resilient base has an extent inwards from the edge of the floorboard 1, which extent can be selected to provide a floorboard 1 with the desired resilience. In brief, the extent of the resilient base on the underside of the floorboard, along the edges as well as transversely thereof, can be varied with a view to optimising both the resilience and the cost of the resilient base.

The material and thickness of the resilient base can be selected on the basis of the application for which the floor is intended. Examples of materials that may be used are expanded rubber or cellular plastics with open or closed cells or equivalent elastic materials. In an embodiment tested by the Applicant, use is made of a resilient base of the type RG 30, which is a cellular plastic resilient base of polyethylene, with closed cells, and which is delivered by National Gummi AB, Halmstad, Sweden. It will be appreciated that the resilient base can be selected among a large number of different materials and thicknesses, depending on the application.

With reference to FIGS. 2a and 2b, a second embodiment will now be described. FIGS. 2a and 2b are detailed schematic cross-sectional views of two edges, provided with a mechanical locking system, of two neighbouring floorboards 1, 1′, which are provided with a resilient base 10 and a supporting layer 11 according to another embodiment of the invention. In FIG. 2a, the floorboards 1, 1′ are arranged next to each other, and in FIG. 2b they are joined together. The supporting layer shown in FIGS. 2a and 2b can be arranged between the resilient base and the underside of the floorboard (i.e. the under-side of the balancing layer 4). The function of the supporting layer 11 is, inter alia, to strengthen the locking system so that it will not be damaged when a joint is subjected to a load from above.

The supporting layer 11 can consist-of any material, such as MDF, HDF, plywood, particle board, wood, metal, such as aluminium, or plastic, and may have any thickness. Alternatively, the supporting layer 11 and the resilient base 10 can be formed in one piece, for instance by that part of the resilient base that is to abut against the underside of the floorboard being heat-treated, and optionally pressed, so that the cell structure collapses and a more rigid layer forms, which layer can serve as a supporting layer.

According to one embodiment, the supporting layer 11 can be formed in one piece with the balancing layer 4. Also in this embodiment, the locking system can be “disengaged” from the supporting layer, i.e. the projecting part 21 of the locking system is not fixed to the balancing layer/supporting layer.

According to one embodiment of the invention, the supporting layer can have substantially the same extent as the resilient base 10.

It will also be appreciated that the extents of the supporting layer 11 and the resilient base 10 can differ from each other. For instance, the entire floorboard can be provided with a supporting layer while the resilient layer is arranged only along the edges of the floorboard.

According to an embodiment tested by the Applicant, the resilient base 10 and the supporting layer 11 have substantially the same extent and extend on the long side 16 mm outside the outer part L2 of the locking system, and on the short side 40 mm outside the outer part L2 of the locking system.

The resilient base 10 can be attached to the underside of the floorboard 1, or to a part thereof by means of arbitrary fastening means. It is possible to use, for instance, glue, rivets, staples, screws, or adhesive tape (double-stick). It is also possible to attach the resilient base to the floorboard by using thermal adhesion, i.e. by heating the material of the resilient base and/or the floorboard in order to cause adhesion. In one embodiment, only part of the surface, facing the floorboard 1, of the resilient base 10 is provided with fastening means. Thus, for instance that part of the resilient base 10 which extends beyond the inner part L1 of the locking system, or that part of the resilient base 10 which extends beyond the joint plane F can be without fastening means, so that the locking system can operate independently, or substantially independently, of the resilient base 10.

According to one embodiment, the supporting layer/resilient base is attached only under that part of the floorboard which does not constitute the locking system.

What has been said above regarding the extent and fixing of the resilient base 10 to the floorboard thus also applies to the supporting layer 11. Likewise the resilient base can be fixed to the supporting layer 11 in one of the ways described with regard to the fixing of the resilient base to the floorboard.

FIG. 3a is a perspective view of a floorboard 1 for a sports floor, which according to a third embodiment of the invention has a mechanical locking system, a resilient base 11 and a supporting layer 10. As shown in FIGS. 3a-3c, the floorboard can be rectangular and thus have long sides 25a, 25b and short sides 26a, 26b.

The sports floor can be based on standard type floorboards 1, 1′, such as those used for parquet floors, laminate floors or wooden floors. Such floorboards usually comprise a core 3 of, for instance, wood, wood slats, plywood, HDF, MDF, fibreboard or like materials. In some applications, however, specially manufactured floorboards may be preferable.

The upper side of the core 3 (FIGS. 1, 2) is provided with a surface layer 2 (FIGS. 1, 2), which serves to make the floorboard resistant to wear, but also to give it an attractive appearance. In wood floors, the surface layer 2 can be made of hardwood, such as oak or maple. In laminate floors, the surface layer may consist of a thin decorative layer laminated with a transparent wear layer (not shown).

The underside of the core 3 (FIGS. 1, 2) can be provided with a balancing layer 4 (FIGS. 1, 2), whose primary function is to prevent the floorboard from bending when the core 3 and the surface layer 2 are expanded to different degrees, for instance owing to variations in moisture content or temperature. The balancing layer 4 can be made of, for example, veneer, laminate film, plywood, HDF, MDF, particle board or like materials.

Moreover, the floorboard shown in FIGS. 3a-3c has a mechanical locking system of the type as described in, for example, WO 99/66151, which allows joining of the floorboard 1 to neighbouring, identical floorboards 1′, so that neighbouring parts of the edge portions of the floorboards 1, 1′ in the joined state define a joint plane F, perpendicular to the main plane P of the floorboards. The joined edge portions of the long sides 25a, 25b define a first joint plane F1, and the joined edge portions of the short sides 26a, 26b define a second joint plane F2.

Furthermore, the underside of the floorboard 1, along a long side 25a and a short side 26a, is provided with an impact-absorbing resilient base 10 and a supporting layer 11 which extend beyond the respective joint planes F1, F2.

Along the long side 25a of the floorboard, the edge portion is provided with a band-like supporting layer 11, which extends on both sides of the joint plane F1 and which extends beyond an outer part L2 (FIGS. 1a, 2a) of the locking system. In the shown embodiment, the resilient base 10 has on the long side substantially the same extent as the supporting layer 11. According to the embodiment shown in FIGS. 3a-3c, the edge portion of the opposite long side 25b is not provided with a supporting layer or resilient base.

The resilient base 10 on the underside of the floorboard 1 gives the sports floor resilience and a shock-absorbing capability. The resilient base 10 is arranged on the floorboard, i.e. it is mounted on-the floorboard in connection with manufacture thereof at the factory.

On the first short side 26a, the edge portion is provided with a band-like supporting layer 11 which extends further beyond the joint plane F2 than do the supporting layer 11 and the resilient base 10 on the edge portion of the long side 25a. Moreover the resilient base on this short side 26a has an extent that corresponds to part of the supporting layer 11.

The edge portion of the second short side 26b has a supporting layer 11 and, arranged thereon, a resilient base 10, which have a smaller extent than the corresponding resilient base/supporting layer on the edge portion of the first short side 26a, and which do not extend beyond the joint plane F2. In one embodiment, the supporting layer 11 and the resilient base 10 on this second short side 26b can be arranged completely-inside an inner part L1 (FIG. 1a) of the locking system of the short side. Also in this case, the extent of the resilient base can correspond to only part of the extent of the supporting layer 11. Arranging a supporting layer/resilient base in this manner on the edge portion of the second short side 26b facilitates laying of the-floor by supporting the floorboard 1 so that it lies flat and stable on the base before being joined to the other floorboards.

Optionally,.the resilient base can be arranged in a band-like portion along the joint. Consequently, the resilient base need not extend over the underside of the entire floorboard, which saves material and which, by the edge portions of the floorboards resting on the resilient base, gives the floorboards a greater degree of resilience, since under that part of the surface of the floorboards which is not provided with the resilient layer, they have a space between the base and the underside of the floorboard. According to the embodiment shown in FIG. 1, this arrangement can be used on the long side as well as on the short side.

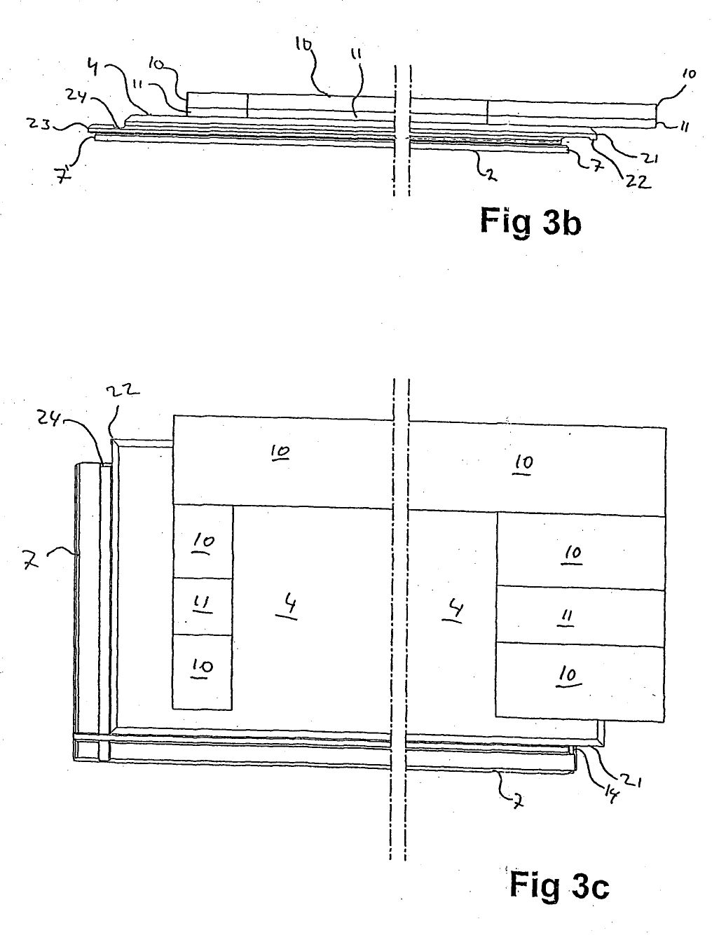

FIGS. 4a-4c illustrate different ways of arranging the resilient base 10, 10a, 10b, 10c and the supporting layer 11, 11a, 11b, 11c on the underside of a floorboard 1, 1′.

In FIG. 4a, a resilient base 10 and optionally a supporting layer 11 of substantially the same size as the floorboard 1, 1′ are arranged on the underside thereof, so that the resilient base/the supporting layer is offset in the longitudinal as well as the transverse direction of the floorboard.

In FIG. 4b, three resilient bases 10a, 10b, 10c and optionally three supporting layers 11a, 11b, 11c are arranged on the underside of the floorboard 1, 1′. First 10a, 11a, and second 10b, 11b resilient bases/supporting layers are arranged in the longitudinal direction of the floorboard 1, 1′, so that the first resilient base/supporting layer 10a, 11a is arranged completely inside the edges of the floorboard, and the second resilient base/supporting layer 10b, 11b is arranged along one of the edges of the floorboard 1, 1′, so that the resilient base/supporting layer extends beyond the joint plane F (not shown). The third resilient base/supporting layer is arranged to extend beyond the joint plane on the short side of the floorboard and also beyond part of the joint plane of the long side.

In FIG. 4c, two resilient bases/supporting surfaces 10a, 10b, 11a, 11b are arranged in the longitudinal direction of the floorboard. The first resilient base/supporting layer extends only beyond the joint plane of the short side, while the second resilient base/supporting layer 10b, 11b extends beyond the joint plane of the short side as well as the long side.

A space between the first and the second resilient bases/supporting layers 10a, 10b; 11a, 11b as shown in

FIGS. 4b and 4c can be formed to modify the resilient function of the floorboards. For instance, a wide space between two supporting layers or resilient bases can be used to give the floorboard better resilience.

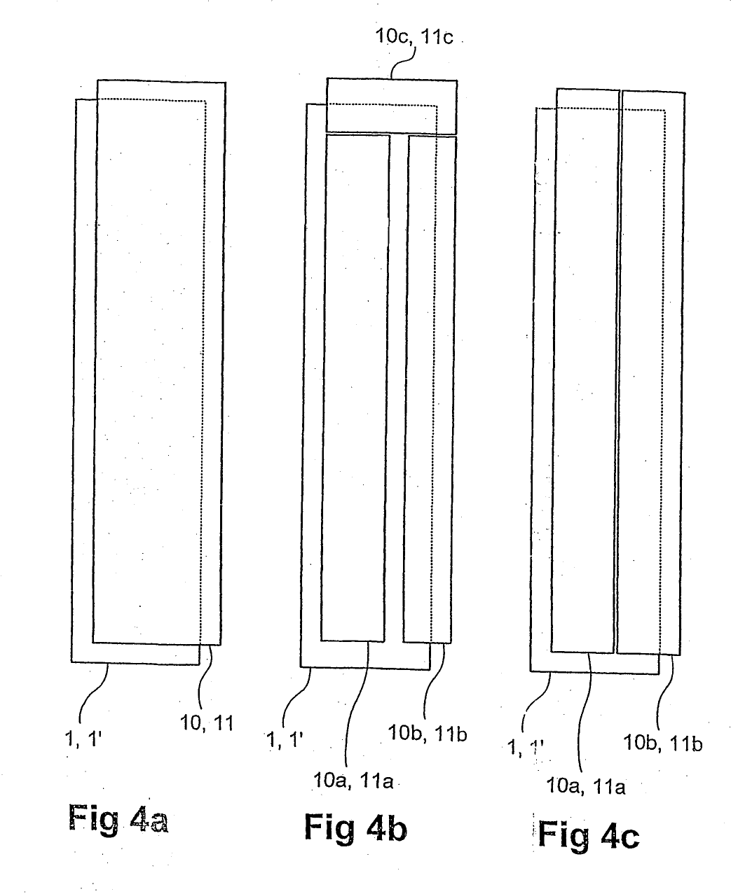

FIG. 5 shows another way of arranging resilient bases 10, 10a, 10b, 10c and supporting layers 11, 11a, 11b, 11c on the underside of a floorboard 1, 1′. In FIG. 5, a plurality of shorter resilient bases/supporting layers 10d, 11d are arranged so as to each extend beyond the joint plane of the long side. At the short side of the floorboard, a resilient base/supporting layer 10c, 11c is arranged to extend beyond the joint plane of the short side as well as the long side.

Also in the embodiment according to FIG. 5, a space between the resilient bases/supporting layers can be used to modify the resilient function of the floorboards.

It will be appreciated that width and length of each of the resilient bases/supporting layers 10, 10a, 10b, 10c, 10d; 11, 11a, 11b, 11c, 11d can be selected to modify the resilient function of the floorboards.

As described above, the floorboard can be provided with a locking system for joining the floorboards. A common variant of locking system is a tongue-and-groove joint, which consists of a tongue which is inserted into a groove and fixed therein by means of glue. In glue joints, the floorboards are joined in the vertical direction D1 by means of the tongue and the groove, and in the horizontal direction D2 by means of the glue. When two floorboards 1, 1′ are joined along their edges, upper neighbouring parts 7, 7′ (FIGS. 1, 2) of edge portions 25a, 25b; 26a, 26b of the floorboards define a joint plane F, which is vertical, i.e. perpendicular to the main plane P of the floorboards. In the case where the floorboard has locking systems on the long sides 25a, 25b as well as the short sides 26a, 26b, first F1 and second. F2 joint planes are defined, which can be orthogonal or substantially orthogonal to each other.

As described above, there are also a plurality of mechanical locking systems, which are capable of joining floorboards without necessitating the use of glue. Thus, a mechanical locking system can mechanically join the floorboards both vertically D1 and horizontally D2. Such a mechanical locking system has the advantage that the laying of the floor will be speeded up while at the same time a durable flooring is obtained, without necessitating the use of glue. This may thus result in reduced use of glue, which may be advantageous from the environmental point of view.

According to one embodiment, the floorboards according to the invention are, along their long sides 25a, 25b and short sides 26a, 26b, provided with such a mechanical locking system. It will be appreciated that anyone of the known mechanical locking systems can be selected and that the locking system on the short sides 26a, 26b need not be of the same type or have the same composition of materials as the locking system on the long sides 25a, 25b.

The floorboard can be manufactured or assembled by a floorboard of prior-art type being provided with the resilient base 10 and optionally the supporting layer 11. According to one embodiment, this is carried out at the factory, and the floorboard is delivered with a resilient base 10 and optionally a supporting layer 11. According to another embodiment, the floorboard and the resilient base are delivered in the form of a kit of parts, which U is joined before the installation of the sports floor. In such a kit of parts, the resilient base can be adjusted in advance in terms of shape and size to be mounted on the floorboard-before laying thereof. Alternatively, the resilient base can be delivered in bulk, for instance on a roll, and then, after cutting, be mounted on the floorboard.

If the kit comprises a supporting layer, this, and also the resilient base, can be mounted on the floorboard, so that the floorboard is delivered with the supporting layer mounted. In this case, the resilient base can be-delivered separately as described above. Alternatively, also the supporting layer can be delivered separately, optionally adjusted in terms of shape and size to be mounted on the floorboard before laying thereof.

It is also possible to provide a kit of parts, which comprises on the one hand a floorboard and, on the other hand, an assembly of supporting layer and resilient base, in which case the assembly can be adjusted in terms of shape and size to be mounted on the floorboard.

In the above-described embodiments of a kit of parts, the floorboard, the supporting layer and/or the resilient base can be provided with fastening means for joining to form a floorboard with the resilient base and the supporting layer, if any, mounted. Such fastening means comprise, but are not limited to, glue, adhesive tape, screw means, rivets and other mechanical fastening means.

It will further be appreciated that the embodiments shown in FIGS. 4a-c and FIG. 5 can be combined, and that it is possible to choose the location of the resilient bases according to one embodiment while at the same time the supporting layer is located according to another embodiment. Other geometric shapes of the resilient base/supporting layer are, of course, also conceivable. It will also be appreciated that the invention may be varied within the scope of the appended claims.

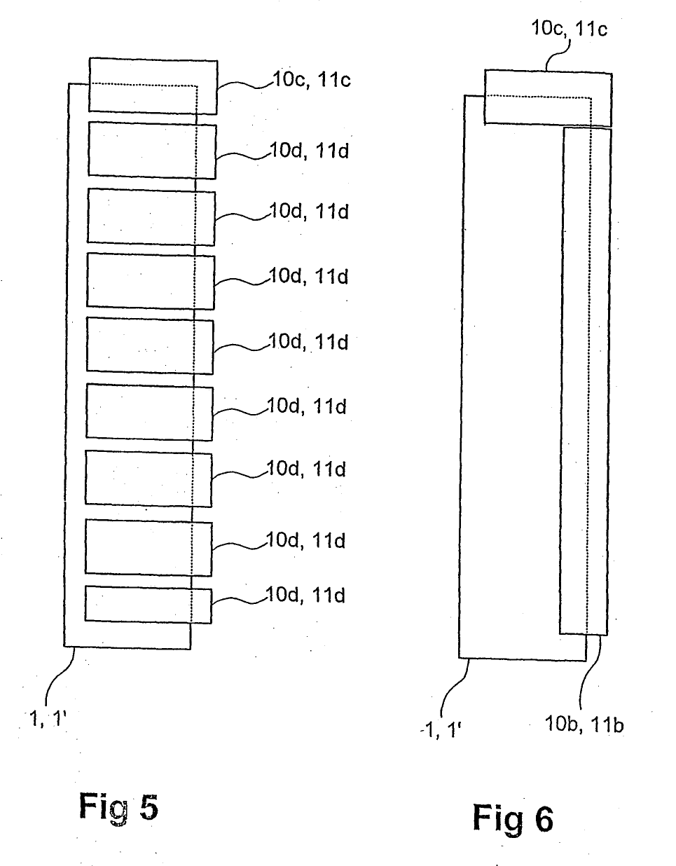

FIG. 6 shows another way in which the resilient base 10b, 10c and/or the supporting layer 11b, 11c can be arranged on the underside of the floorboard. In this embodiment, a first resilient base 10b and/or supporting layer 11b is arranged on the long side of the floorboard in such a manner that it extends beyond the joint plane F of the long side and extends along substantially the entire length of the long side. The extent of the resilient base inside the joint plane F can be substantially smaller than the width of the floorboard, and in one embodiment substantially smaller than half the width of the floorboard. In further embodiments, the extent inside the joint plane can be, for instance, ⅓, ¼, ⅕ or ⅙ of the width of the floorboard. In still further embodiments, the extent can be from 1 cm up to 5 or 10 cm. The extent outside the joint plane F can also be adjusted to what turns out to be convenient. In one embodiment, the resilient base 10b and/or the supporting layer 11b extends outside the outer part L2 of the locking system. For instance, the extent can be between 0 and 10 cm from the outer part L2 of the locking system, but a greater extent is not excluded, especially if large floorboards are used.

A second resilient base 10c and/or supporting layer 11c is arranged on the short side of the floorboard and extends beyond the joint plane F of the short side and extends along substantially the entire length of the short side. Regarding the extent inside and outside the joint plane of the short side, reference is made to that described with regard to the long side.

It will be appreciated that the extent inside and outside the joint plane F of the short side and also the extent inside and outside the joint plane F of the long side can be selected independently of each other.

Besides, the resilient base 10b, 10c and/or the supporting layer 11b, 11c in FIG. 6 can be arranged and fixed to the floorboard analogously to what has been described above with reference to FIGS. 1 and 2.

1. A floorboard for making a resilient floor by joining to at least one neighbouring, substantially identical floorboard, so that joined upper neighbouring parts of the edge portions of the floorboards together define a joint plane, perpendicular to the main plane of the joined floorboards, the floorboard comprising:
a resilient base, arranged on the underside of the floorboard and extending beyond said joint plane,
a supporting layer, arranged between an underside of the floorboard and the resilient base, and
a locking system, arranged along at least two parallel edges of the floorboard and integrated with the floorboard, for mechanical joining, vertically and horizontally, of the floorboard to the neighbouring, substantially identical floorboard.

2. A floorboard as claimed in claim 1, wherein the resilient base is arranged so that, with the floorboards in a joined state, it extends at least partly under the neighbouring, substantially identical floorboard.

3. A floorboard as claimed in claim 1, wherein the resilient base is made of an elastic material.

4. A floorboard as claimed in claim 3, wherein said elastic material comprises at least one of expanded rubber and cellular plastic.

5. A floorboard as claimed in claim 1, wherein the supporting layer has a horizontal extent which is at least as great as a horizontal extent of the resilient base.

6. A floorboard as claimed in claim 1, wherein the horizontal extent of the supporting layer is smaller than a horizontal extent of the floorboard.

7. A floorboard as claimed in claim 6, wherein the horizontal extent of the supporting layer is less than half the horizontal extent of the floorboard.

8. A floorboard as claimed in claim 1, wherein the supporting layer has a greater modulus of elasticity than the resilient base.

9. A floorboard as claimed in claim 1, wherein the supporting layer includes at least one of MDF, HDF, plywood, particle board, wood material, plastic material and metal.

10. A floorboard as claimed in claim 1, wherein the resilient base extends beyond an outer part (L2) of the locking system of the floorboard.

11. A floorboard as claimed in claim 1, wherein the long sides of the floorboard and the short sides of the floorboard are provided with respectively first and second mechanical locking systems integrated with the floorboard, for mechanical joining, vertically and horizontally, of the floorboard to neighbouring, substantially identical floorboards, so that joined upper neighbouring parts of the edge portions of the long sides and short sides, respectively, together define first and second joint planes which are perpendicular to the main plane of the joined floorboards, the resilient base at the edge portion of a short side and the edge portion of a long side extending beyond the respective joint planes.

12. A floorboard as claimed in claim 11, wherein the resilient base at the edge portion of the short side extends further beyond the first joint plane than beyond the second joint plane at the edge portion on the long side.

13. A flooring for resilient floors, comprising a plurality of floorboards according to claim 1.

14. A kit of parts for making a resilient floor, comprising:
a floorboard for joining to a neighbouring, substantially identical floorboard, so that joined upper neighbouring parts of the edge portions of the floorboards together define a joint plane, which is perpendicular to the main plane (P) of the joined floorboards,
a resilient base, which in terms of shape and size is adapted to be arranged on the underside of the floorboard, so that the resilient base extends beyond said joint plane, and
a supporting layer, which in terms of size and shape is adapted to be arranged between said floorboard and said resilient base, the floorboard along at least two parallel edges, being provided with a locking system integrated with the floorboard, for mechanical joining, vertically and horizontally, of the floorboard to the neighbouring, substantially identical floorboard.

15. A kit of parts as claimed in claim 14, wherein the resilient base is provided with at least one fastening device, arranged on the underside of the floorboard.

16. A kit of parts as claimed in claim 14, wherein the underside of the floorboard is provided with fastening means for arranging the resilient base.

17. A kit of parts as claimed in claim 14, wherein the supporting layer is provided with at least one fastening device, arranged between said floorboard and said resilient base.

18. A kit of parts as claimed in claim 14, wherein said resilient base has a first horizontal extent which is substantially equal to a length of a first edge of the floorboard, and a second horizontal extent which is less than half a length of a second edge of the floorboards.

19. A method for making a resilient floor by joining a floorboard to a neighbouring, substantially identical floorboard so that joined upper neighbouring parts of the edge portions on the floorboards together define a joint plane, which is perpendicular to the main plane of the joined floorboards, the method comprising:
joining the floorboards so that a resilient base and a supporting layer, arranged on the underside of the floorboard, extend beyond said joint plane,
said joining including mechanical joining, vertically and horizontally, of the floorboard to the neighbouring, substantially identical floorboard.

20. A method for manufacturing a floorboard for making a resilient floor, comprising:
providing a floorboard, designed for joining to a neighbouring, substantially identical floorboard, so that joined upper neighbouring parts of the edge portions of the floorboards together define a joint plane, which is perpendicular to the main plane of the joined floorboards,
arranging to the underside of the floorboard a resilient base, which extends beyond said joint plane,
arranging a supporting layer between said floorboard and said resilient base, and
arranging along at least two parallel edges of the floorboard a locking system integrated with the floorboard, for mechanical joining, vertically and horizontally, of the floorboard to the neighbouring, substantially identical floorboard.
